(19) United States
(12) Patent Application Publication
(10) Pub. No.: US 2020/0142372 A1
(43) Pub. Date: May 7, 2020

(54) Water-Related Signal Operations in Complex Computing Networks

(71) Applicant: Veles Water Limited, London (GB)

(72) Inventor: Lance R.C. Coogan, Sevenoaks (GB)

(21) Appl. No.: 16/723,303

(22) Filed: Dec. 20, 2019

Related U.S. Application Data
(63) Continuation-in-part of application No. PCT/IB2018/054632, filed on Jun. 22, 2018.
(60) Provisional application No. 62/524,378, filed on Jun. 23, 2017.

(51) Int. Cl. G05B 19/042

(52) U.S. Cl. CPC G05B 19/042; G05B 2219/2625

(57) ABSTRACT

Water is inextricably tied to all aspects of life. Networks of water systems around the world are disparate, disconnected, and unevenly distributed. Embodiments disclosed herein are directed to communicating with disparate water-related input signal systems, performing complex computations on water-related input signals received from the water-related input signal systems, and generating water-related output signals. The water-related output signals may be used to more efficiently store and distribute water for present and future water consumption and other uses.

### CROSS-REFERENCE TO RELATED APPLICATIONS

This application is a continuation-in-part of and claims priority to PCT Application No. PCT/IB2018/054632, filed on Jun. 22, 2018, titled “Water-Related Signal Operations in Complex Computing Networks,” which claims priority to U.S. Provisional Application No. 62/524,378, filed on Jun. 23, 2017, titled “Water-Related Signal Operations in Complex Computing Networks,” all of which are incorporated by reference in their entirety for all purposes.

### BACKGROUND

Water is inextricably tied to all aspects of life. Networks of water supplier and consumer systems around the world are disparate, disconnected, and unevenly distributed. There is a need to connect the water systems of the world to produce water data that can be used to more efficiently store and distribute water for present and future water consumption and other uses.

### BRIEF SUMMARY

In some embodiments, an apparatus is provided for communicating with disparate water-related input signal systems and generating water-related output signals, wherein the communicating and generating processes are necessarily rooted in computing technology. The apparatus comprises a signal communication interface for: establishing a first connection to a first water-related input signal system, the first water-related input signal system being associated with a first water supplier, the first water supplier being associated with a first water conduit; receiving a first input signal on the first connection, the first input signal comprising first water data; establishing a second connection to a second water-related input signal system, the second water-related input signal system being associated with a second water supplier, the second water supplier being associated with a second water conduit; receiving a second input signal on the second connection, the second input signal comprising second water data; establishing a third connection to a computing device; and transmitting an output signal to the computing device, the output signal comprising a water index.

The apparatus further comprises a signal processor (e.g., a digital signal processor, an analog signal processor, a mixed digital and analog signal processor, etc.) for: determining a first computation technique of the water index, the first computation technique of the water index being determined at a prior time; determining a triggering event for modifying the first computation technique; modifying, based on the triggering event, at least one component of the first computation technique; determining a first supply volume associated with the first water supplier; modifying the first water data based on the first water supply volume associated with the first water supplier; determining a second supply volume associated with the second water supplier; modifying the second water data based on the second water supply volume associated with the second water supplier; determining a water use metric (e.g., water consumption volume); modifying the water use metric using a consumable water weighting technique, the consumable water weighting technique used for removing at least some unusable water volume (or any other unusable water metric) or waste water volume (or any other waste water metric) from the water use metric; and computing, using the modified first computation technique, the water index based on the modified first water data, the modified second water data, and the modified water use metric.

In some embodiments, the consumable water weighting technique comprises applying a consumable water weighting factor to the water use metric. In some embodiments, the consumable water weighting factor is associated with electro-thermal cooling associated with water. In some embodiments, at least some of the water that is received, from a water source system, at a system that performs electro-thermal cooling of the water, is returned to the water source system. In some embodiments, a portion (e.g., approximately 96% or any other percentage) of the water is returned to the water source system in a warmer state compared to the state in which the water was received by the system performing the electro-thermal cooling. Both the water source system and the system that performs electro-thermal cooling of water are examples of water systems.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1A shows a method in accordance with a specific example embodiment of the disclosure;

FIG. 1B shows another method in accordance with a specific example embodiment of the disclosure;

FIG. 2 shows a system diagram in accordance with a specific example embodiment of the disclosure;

FIG. 3A shows a functional diagram in accordance with a specific example embodiment of the disclosure;

FIG. 3B shows a system diagram in accordance with a specific example embodiment of the disclosure.

In the various figures, the same reference numbers are provided for the same system elements, whereas in other instances similar elements shown in different figures may have different reference numbers. The figures and associated description provide a plurality of different embodiments and similar elements among the figures will illustrate to one of ordinary skill in the art the possible functionality and connection of those elements in the multiple and collective embodiments disclosed herein.

### DETAILED DESCRIPTION

Water is used in residential applications, industrial applications, retail systems, irrigation equipment, utilities, bottled water products and services, etc. Residential applications include water-related equipment and service for supplying water to and enabling consumption in residential homes. Industrial applications include water-related equipment and services supplied to various industrial entities. Retail systems include water filters, heating and cooling systems, etc. Water distribution plants are used to distribute water from water sources or suppliers for use in residential applications, industrial applications, retail systems, irrigation equipment, utilities, bottled water products and services, etc. Water treatment plants are used to treat water to ensure that the treated water is suitable for various application described herein. The management of waste water is also important. Sewer systems, waste water treatment plants, and water recycling facilities are used to manage and transport waste water.

The U.S. has a daily water volume of 355 billion gallons. Part of this volume can be transferred again during the day; hence the actual volume is more than 355 billion gallons. This volume does not include relative trades of water such as water versus beef, water versus corn, water versus oil, water versus shale gas, etc.

Water may include physical water or water data. Water may refer to at least one of clean water, drinkable water, dirty water, mix of clean and dirty water, processed water, unprocessed water, fresh water, salty water, brackish water, grey water, distilled water, hot water, cold water, hard water, soft water, filtered water, unfiltered water, treated water, untreated water, rain water, stream water, river water, sea water, ocean water, manufactured water, waste water, spring water, potable water, any combinations thereof, etc. The meaning of water may change from one context to another, and is not limited to any particular form or type of water. Water data may include data about water in the past, present, or future. Water-related data may be used interchangeably with water data. Water data may include water volume data, water temperature data, water price data, water index data, intermediate calculation data leading to the water index data, water quality data, water source data, water supplier data (e.g., how many suppliers in a particular region, total volume of water supplied, value of water supplied in terms of U.S. dollars or other currencies, etc.), residential data (e.g., how many homes in a particular region or associated with an index, total volume of water consumed in a particular region or associated with an index, etc.), industrial data (e.g., how many industrial entities associated with a particular region or index, total volume of water consumed in a particular region or associated with an index, etc.), water consumer data, computation data, operational data for any system described herein, system data associated with any system described herein, water system data, user data, authentication data, drought conditions data associated with a particular region, population data associated with a particular region, weather data, speed of water supply or water consumption data, chemical content data, sediment data, water infrastructure data (e.g., pipes and other equipment for water storage, supply or consumption), raw water data, processed water data, pre-processed water data, post-processed water data, consumable water data, usable water data, unusable water data, waste water data, virtual water-based product or instrument data, derivative data associated with any virtual water-based products, water-based product data, water-based services data, water-based trading data, any other water use metric data, water supply, water rights, water access, water, etc. The term “water data” is meant to be all encompassing and may include any data described herein associated with any system, including any water systems. In some embodiments, the terms “data” and “water data” may be used interchangeably.

Water data, e.g., the chemicals or salts in the water or the price of water, may vary from one city to another city, one country to another country, one region to another region, etc. Aggregate water data may include a computation (e.g., a sum, a product, a complex computing calculation, etc.) of water data or based on water data for one or more geographical regions, water systems, etc. In some embodiments, the term “water” may represent any other solid, liquid, or gaseous commodity. In some embodiments, water may refer to any other physical or virtual commodity that is mixed or integrated into water or is associated with water. Water volume may refer to volume being used, supplied, or consumed by a single water system (or multiple water systems) or water being exchanged, traded, supplied, consumed, or otherwise transferred between two or more water systems. Any transfer, trading, or exchange of water described herein may refer to water being sold, traded, or otherwise transferred from one entity to another. In some embodiments, any references to water data include average water data, weighted water data (e.g., volume weighted water data), or any other simple or complex calculation involving water data. The term “data” may be equivalent to signal, information, or the like. Alternatively or additionally, a signal may be used to carry data or information. In some embodiments, any signals described herein may be non-transitory signals. In other embodiments, any signals described herein may be transitory signals.

Any water system described herein may refer to at least one of a water input system, a water output system, a water storage system, a water source system, a water transmission system, a water reception system, a water mixing system, a water separation system, a water processing system, a water cleaning or treatment system, water infrastructure, irrigation equipment, a utility system, a bottled water manufacturing or storage system, a retail system, a water banking system, dams, a computing system, including an intelligent computing system, integrated into, comprising, or comprised in the water system, an exchange platform, a water-related system, etc. Any intelligent system described herein may, over time, learn to modify, fine-tune, or configure any water data or modify, fine-tune, or configure computational techniques described herein. Any system, computing or non-computing, described herein may fall under the definition of “water system.” In some embodiments, the terms system, device, apparatus, server, etc., and “water system” may be used interchangeably. The computing device may be any server, host, non-portable computing device, portable computing device, mobile device, mobile phone, wearable device, etc. Water banking systems, dams, and other water storage systems that may be used to store water may also be considered as types of water systems. Water exchanges may be used to transfer water from one water system to another water system or transfer electronic representations of water from one water-related system to another. In some embodiments, any water system described herein comprises one or more sensors for determining, e.g., upon receiving an instruction or periodically, a water consumption amount, a water supply amount, a usable for consumption water amount, a unusable for consumption water amount, any other water use metric, etc. The term “consumption” may refer to water consumption or water use for any application described herein. In some embodiments, water consumption may refer to any water use, and water consumption volume may refer to any water use metric. The example procedures for calculating indexes, as described herein, use water consumption data (e.g., water consumption volume or amount) as a component of the computations. The water consumption data in these procedures may be replaced with other water use metrics, including but not limited to those described herein.

Water systems may be associated with entities or persons. As an example, a water system may be associated with a registered or authenticated provider. The registered or authenticated provider may be a utility or utility-related entity which provides water. The registered provider may provide water data (e.g., water consumption data or any other water use metric data) to one or more other water systems described herein. As a further example, a water system may be associated with an industrial consumer that consumes at least a certain volume of water for industrial purposes (e.g., power generation, natural gas, oil production, manufacturing, etc.), or an agricultural consumer (e.g., food production, irrigation of crops, sustainment of livestock, etc.) that consumes at least a certain volume of water for agricultural purposes, a large consumer that consumes that consumes at least a certain volume of water, a small consumer that does not consume the volume of water required for categorization as a large consumer, etc.

Water data may include, be comprised in, or may be to be used to generate water indices. Water indices may include a global water index, country-specific indices, continent-specific indices, city water indices, industrial water indices, agricultural water indices, other regional indices, etc. In some embodiments, a water index may be based on a type of water, including but not limited to, any type of water described herein. In some embodiments, a water index may be based on water data, including but not limited to, any type of water data described herein. In some embodiments, a water index may be based on the purpose for which the water or water data, upon which the water index is based, is used for, including but not limited to any applications described herein. For example, the water or water data may be used for consumption purposes, manufacturing purposes, water treatment purposes, residential purposes, medical purposes, industrial purposes, agricultural purposes, retail systems, bottled water products and services, other water products and/or services, etc. As an example, a water index may be a volume-weighted and/or other water data-weighted index encompassing a certain number (e.g., one or more) of geographical areas (e.g., cities, towns, districts, states, countries, continents, etc.) in one or more other larger geographical areas (e.g., countries, continents, hemispheres, etc.). In some embodiments, the geographical areas associated with the index may be located in a single larger geographical area (e.g., cities in a state) or the geographical areas may be located in multiple larger geographical areas (e.g., cities in multiple states). A geographical region or area as described herein may refer to a physical geographical region or area or a computing network region or area (e.g., computing devices, servers, networks, etc., located in one or more geographical regions). A geographical region or area may refer to one or more contiguous sub-regions or sub-areas or one or more non-contiguous sub-regions or sub-areas. A geographical region or area may also be referred to as a market. In some embodiments, any index described herein may be based on average water data or weighted average water data for public supply of water.

The present disclosure relates to receiving water data from disparate and disconnected water systems (e.g., utilities, water providers, etc.), assimilate the water data, perform calculations on the water data, and produce transformed water data that can be used for many purposes.

In some embodiments, a method is provided for determining a volume-weighted average water data index. The index may be constructed by weighting volume of water consumption (or any other water use metric) where, if more than one water supplier exists in a particular geographical region, average data is used for the more than one water supplier. For example, the total volume of water for all geographical regions (e.g., cities) in an index may be multiplied by the water data to obtain aggregate water data. The aggregate water data may be a total market value for the index. The total market value may be divided by the total volume (e.g., of water supplied and/or consumed in the geographical region) to arrive at a volume weighted average data index.

In some embodiments, a volume-weighted average data index is described. This index is float-adjusted for market volume rather than full volume, to reflect actual volume of water available for consumption in a particular market. Water consumption amounts (or any other water use metrics) may be received from one or more water systems (e.g., associated with one or more water suppliers) associated with one or more regions. The received consumption amount from a particular region is subject to (e.g., multiplied by) or processed (e.g., using a complex computing calculator) with a consumable weight factor (CWF) which acts as a mechanism to remove waste and/or unusable for consumption water from the index for a specific area. This processing accounts for electro-thermal cooling.

In some embodiments, at least some of water that is received, from a water source system, at a system that performs electro-thermal cooling of the water, is returned to the water source system. In some embodiments, a portion (e.g., approximately 96% or any other percentage) of the water is returned to the water source system in a warmer state compared to the state in which the water was received by the system performing the electro-thermal cooling. In other embodiments, the portion of the water is returned to the water source system in a cooler state compared to the state in which the water was received by the system performing the electro-thermal cooling. Both the water source system and the system that performs electro-thermal cooling of water are examples of water systems.

The volume-weighted index is calculated by dividing a first quantity by a second quantity. In some embodiments, the first quantity comprises taking the sum of the average water data from water suppliers in a particular geographical region and multiplying, or otherwise processing (e.g., using a complex computing calculator), the sum of the average water data by the total water consumption for that region, and then subjecting or processing or multiplying the result with a consumable weight factor. As explained previously, the total water consumption is a sum of water consumption amounts received from one or more water systems (e.g., associated with one or more suppliers) in a particular region. The consumable weight factor may vary from one region to another region. In other embodiments, a consumable weight factor may be applied to the raw total water consumption amount, whereas in other embodiments, individual consumable weight factors may be applied to water consumption amounts associated with particular regions or suppliers. The second quantity comprises one or more divisors.

In other embodiments, the first quantity includes summing, for all suppliers, water data of a supplier multiplied by volume of water supplied by the supplier, and multiplying or otherwise processing the sum with a consumable weight factor. The water data may be as of a particular day/time or average water data for a period of time. In other embodiments, a consumable weight factor is applied to each product of water data of a supplier and volume of water supplied by the supplier. The second quantity comprises one or more divisors.

In some embodiments, a volume and water data weighted water index is described. This approach includes weighting the volume (e.g., water supply and/or water consumption, etc.) of each water region and applying a weighting to a region's water data if more than one supplier exists in that region. This may give a more accurate representation of the water data in a particular region where market share between suppliers is not equally split and if a large water data differential exists between different suppliers in the region.

The volume and water data weighted index is calculated by dividing a first quantity by a second quantity. In some embodiments, the first quantity comprises taking the sum of the weighted water data from water suppliers in a particular geographical region and multiplying, or otherwise processing (e.g., using a complex computing calculator), the sum of the weighted water data by the total water consumption for that region, and then subjecting or processing the result with a consumable weight factor. As explained previously, the total water consumption is a sum of water consumption amounts received from one or more water systems (e.g., associated with one or more water suppliers) in a particular region. The consumable weight factor may vary from one region to another region. In other embodiments, a consumable weight factor may be applied to the raw total water consumption amount, whereas in other embodiments, individual consumable weight factors may be applied to water consumption amounts associated with particular regions or suppliers. The second quantity comprises one or more divisors. The weighted water data for each supplier may comprise water data (e.g., water content, water price or value of supply in U.S. dollars or in other currency, or any other water data) associated with the supplier divided by either the total volume (or total adjusted volume) of supply in the region or the volume of water supplied by the supplier. The total adjusted volume of supply in a region is a total volume of supply subjected to the consumable weight factor described herein.

In some embodiments, the water data associated with larger volume supplier in a region has a bigger impact on the overall water data for the region or the water index compared to smaller volume supplier. In some embodiments, the weighted water data for each supplier may comprise water data (e.g., water content, water price or value of supply in U.S. dollars or in other currency, or any other water data) associated with the supplier multiplied by the volume of water supplied by the supplier in the region and divided by the total volume (or total adjusted volume) of supply in the region.

In other embodiments, the first quantity includes summing, for all suppliers, weighted water data of a supplier multiplied by volume of water supplied by the supplier, and multiplying or otherwise processing the sum with a consumable weight factor. The weighted water data may be as of a particular day/time or average weighted water data for a period of time. In other embodiments, a consumable weight factor is applied to each product of weighted water data of a supplier and volume of water supplied by the supplier. The second quantity comprises one or more divisors.

Components that make up the index may change from one day to the other. In order to insulate the index from changes in a water supplier, the divisor associated with the index generation process may be adjusted using a balancing process. A change may include the addition, deletion, or replacement of a water supplier that is used in the generation of the index. A change may include a change in the volume of water supply (e.g., increase or decrease by at least 10%) associated with a water supplier. In some embodiments, a change in the water supplier may include a corporate action associated with the water supplier. The process for calculating a new divisor after a change event associated with a supplier is as follows. The new divisor is calculated by multiplying the divisor prior to the change event with a second quantity. The second quantity includes a numerator and a denominator. The numerator includes combining (e.g., adding, subtracting, or other complex computing calculation) a third quantity and a fourth quantity. The denominator of the second quantity includes the third quantity. The third quantity includes summing, for all suppliers, water data of a supplier prior to the change event multiplied by volume of water supplied by the supplier prior to the change event.

Where a new water supplier needs to be included in the index generation process, the fourth quantity, which is added to the third quantity, includes water data of the new water supplier after the change event multiplied by the volume of water supplied by the new supplier after the change event. Where an existing supplier in the index generation process is removed, the fourth quantity, which is subtracted from the third quantity, includes water data of the existing supplier before the change event multiplied by the volume of water supplied by the existing supplier before the change event. If the current water data for any supplier is not available, the most recent available water data is used for that supplier. In some embodiments, the water data may be a water price, water value, water content data, or any other water data described herein. Any reference to a volume of water associated with any supplier in a region may alternatively refer to a relative volume of water associated with the supplier in the region relative to the total water supply in the region.

In some embodiments, an industrial water index is provided. Any water suppliers that supply water associated with water data that is used to generate the industrial water index need to provide at least a certain volume of water for industrial use. Additionally, the water suppliers may need to supply water using pipes associated with certain parameters (e.g., width, diameter, length, etc.). For example, the width of water pipes associated with suppliers associated with this index may be ˜4 inches. In some embodiments, any water system from a water supplier that provides water data used to calculate this index may need to be authenticated periodically or prior to, during, or after every transmission of water data to a computing system that generates the index.

In some embodiments, an agricultural water index is provided. Any water suppliers that supply water associated with water data that is used to generate the agricultural water index need to provide at least a certain volume of water for agricultural use. Additionally, the water suppliers may need to supply water for agricultural use using pipes associated with certain parameters (e.g., width, diameter, length, etc.). In some embodiments, any water system from a water supplier that provides water data used to calculate this index may need to be authenticated periodically or prior to, during, or after every transmission of water data to a computing system that generates the index. The industrial or agricultural index may be associated with particular regions (e.g., north-eastern USA, south-western USA, etc.).

In some embodiments, a regional water index is provided. Any water suppliers that supply water associated with water data that is used to generate the regional water index need to be located in and provide at least a certain volume of water in the region associated with the index. The location of a water supplier may be determined based on the location of water pipes, water systems such as water transmission systems or water storage systems, water treatment systems, dams, water diversion systems, water exchange systems, computing systems, etc. The water suppliers associated with this index may include suppliers that supply water using pipes of certain parameters (e.g., ˜2 to ˜4 inches pipe width). Additionally, the water suppliers may need to use pipes associated with certain other parameters (e.g., diameter, length, etc.). In some embodiments, any water system from a water supplier that provides water data used to calculate this index may need to be authenticated periodically or prior to, during, or after every submission of water data to a computing system that generates the index.

In some embodiments, a city index is provided. The city index may comprise a certain number of cities in a particular geographical region (e.g., north-eastern USA, south-western USA, etc.) and/or a number of cities to represent multiple geographical regions in a country. Any water suppliers that supply water associated with water data that is used to generate the city water index need to be located in and provide at least a certain volume of water in at least one of cities associated with the index. The location of a water supplier may be determined based on the location of water pipes, water systems such as water transmission systems or water storage systems, water treatment systems, computing systems, etc. The water suppliers associated with this index may include suppliers that supply water using pipes of certain parameters (e.g., ˜¾ inch-˜2 inch pipes). Any volume of water described herein may be an absolute volume of water, i.e., a certain number of gallons, or a relative volume of water, i.e., a certain percentage of the water supply in a particular region such as a city. Any feature associated with one index may be applicable to any of the other indices described herein.

In some embodiments, cities that are selected to be part of the city index may be based on determining water stress in geographical regions where the cities are located. The index is based on cities associated with geographical regions with varying water data. For example, in one geographical region (e.g., the northeast USA) where there is a large population and aging water infrastructure, the water data may be different from another region with a smaller population and newer water infrastructure. As a further example, water data in a geographical region (e.g., southwest USA) may be influenced by water scarcity, i.e., the availability of water, and/or drought conditions in the region.

In some embodiments, a product specific index is provided. For example, the product specific index may be a fracking index. In some embodiments, a cross-product index is provided. The cross product index may be a water versus beef index, a water versus corn (or wheat, oil, shale gas, energy, etc.) index, etc. The index may be calculated based on water data and data associated with one or more other commodities or assets (e.g., a particular commodity or a basket index such as the consumer price index), or any other economic or measurable variable. For example, the index may be water divided by data associated with one or more other commodities. In some embodiments, a cross-international index is provided. The index may be calculated based on water data in one geographical region (e.g., a city in the U.S.) and based on water data in another geographical region (e.g., a city in China). In some embodiments, a niche index is provided. For example, the niche index may be based on water rights.

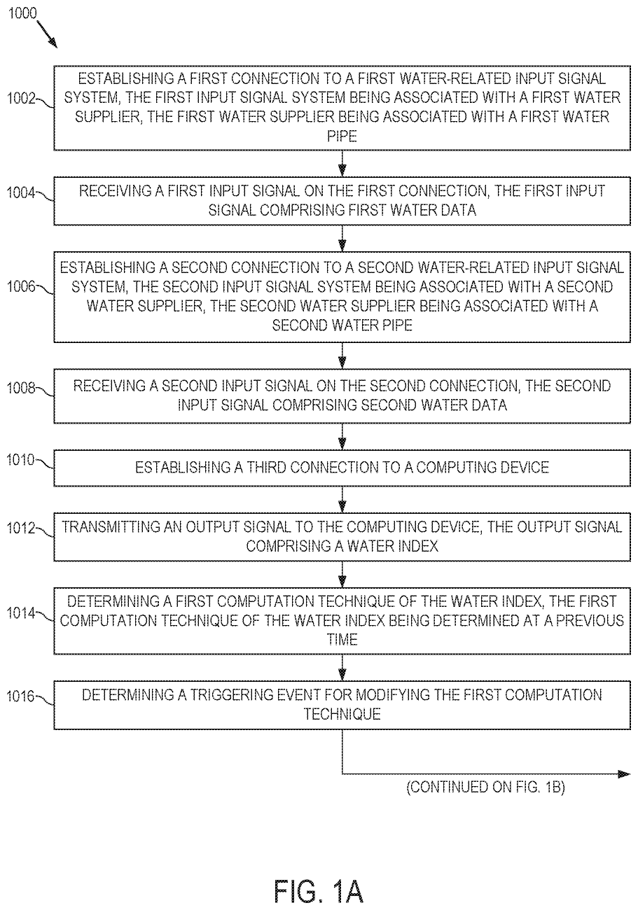

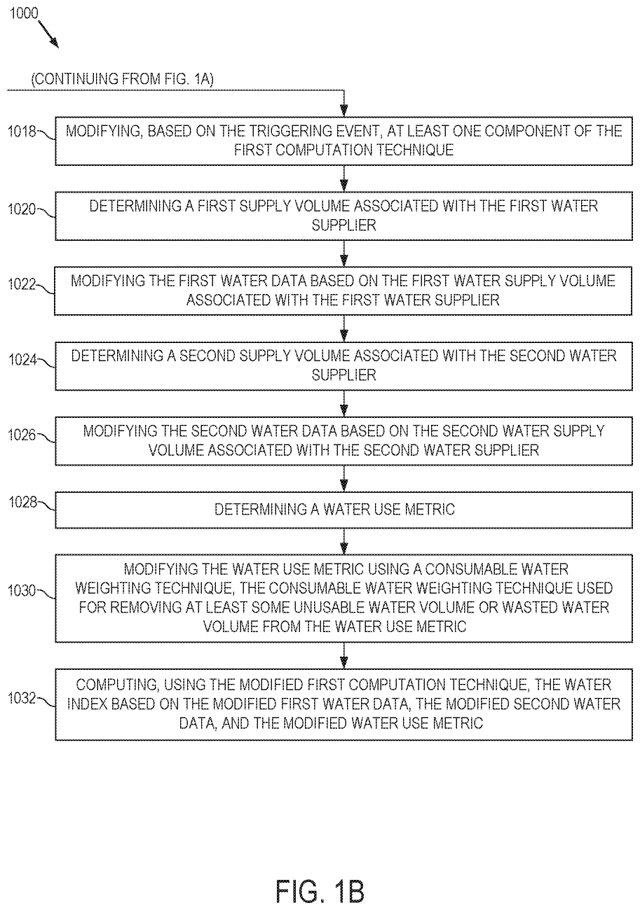

Referring now to the figures, FIGS. 1A and 1B illustrate a method 1000, in accordance with a specific example embodiment, using one or more of systems, either singly or in combination, described herein. The various blocks of the method 1000 may be executed in any order and are not limited to the order described herein. The various blocks of the method 1000 may be executed by any system or apparatus described herein. Some of the blocks may be optional.

At block 1002, the method comprises establishing, using one or more computing device processors, a first connection to a first water-related input signal system, the first input signal system being associated with a first water supplier, the first water supplier being associated with a first water pipe. At block 1004, the method comprises receiving, using the one or more computing device processors, a first input signal on the first connection, the first input signal comprising first water data. At block 1006, the method comprises establishing, using the one or more computing device processors, a second connection to a second water-related input signal system, the second input signal system being associated with a second water supplier, the second water supplier being associated with a second water pipe. At block 1008, the method comprises, receiving, using the one or more computing device processors, a second input signal on the second connection, the second input signal comprising second water data. At block 1010, the method comprises establishing, using the one or more computing device processors, a third connection to a computing device. At block 1012, the method comprises transmitting, using the one or more computing device processors, an output signal to the computing device, the output signal comprising a water index.

At block 1014, the method comprises determining, using the one or more computing device processors, a first computation technique of the water index, the first computation technique of the water index being determined at a prior time (e.g., a previous time). At block 1016, the method comprises determining, using the one or more computing device processors, a triggering event for modifying the first computation technique. At block 1018, the method comprises modifying, using the one or more computing device processors, based on the triggering event, at least one component of the first computation technique. In some embodiments, blocks 1014, 1016, and 1018 are optional. In such embodiments, the same computation technique may be used as in previous instances, i.e., the computation technique is not modified.

At block 1020, the method comprises determining, using the one or more computing device processors, a first supply volume associated with the first water supplier. At block 1022, the method comprises modifying, using the one or more computing device processors, the first water data based on the first water supply volume associated with the first water supplier. In some embodiments, blocks 1020 and 1022 are optional. In such embodiments, the first water data may not be modified. Any volume of water described herein may be measured in liters, gallons, acre feet, or any other metric.

At block 1024, the method comprises determining, using the one or more computing device processors, a second supply volume associated with the second water supplier. At block 1026, the method comprises modifying, using the one or more computing device processors, the second water data based on the second water supply volume associated with the second water supplier. In some embodiments, blocks 1024 and 1026 are optional. In such embodiments, the second water data may not be modified.

At block 1028, the method comprises determining, using the one or more computing device processors, a water use metric. At block 1030, the method comprises modifying, using the one or more computing device processors, the water use metric using a consumable water weighting technique, the consumable water weighting technique used for removing at least some unusable water volume or waste water volume from the water use metric. In some embodiments, the unusable water volume or other metric and/or waste water volume or other metric may be used in or by the consumable water weighting technique to modify the water use metric. In some embodiments, block 1028 is optional. In such embodiments, the water use metric may not be modified.

At block 1032, the method comprises computing, using the one or more computing device processors, using the modified first computation technique, the water index based on the modified first water data, the modified second water data, and the modified water use metric.

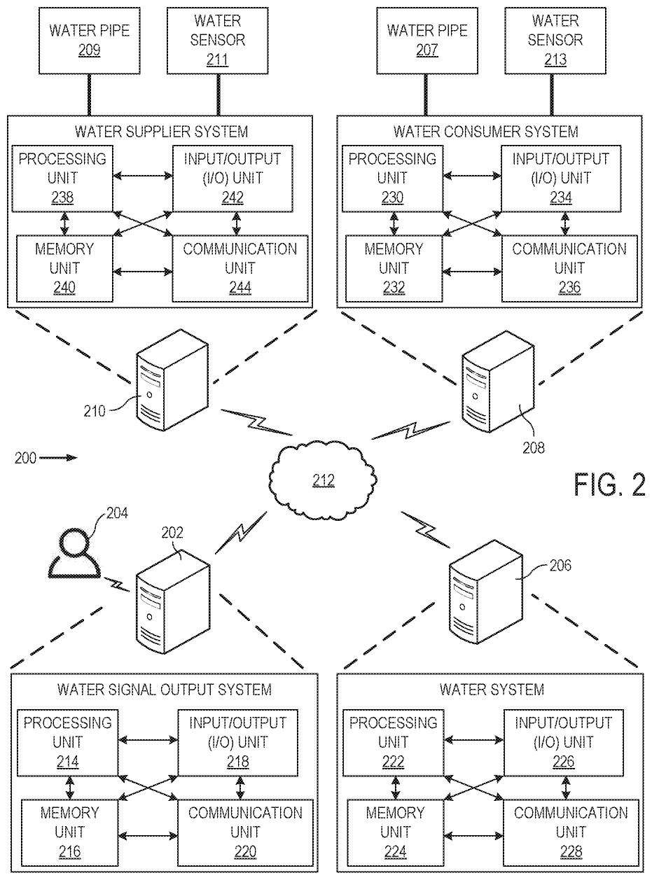

FIG. 2 illustrates a more detailed system 200, in accordance with a specific example embodiment, for performing various operations as described herein (e.g., as described in the illustrative example of FIG. 1). In some embodiments, the system 200 may include a water signal output system 202 of a user 204, a water system 206, a water consumer system 208 (may be connected to a water pipe 207 and/or a water sensor 213), and a water supplier system 210 (may be connected to a water pipe 209 and/or a water sensor 211). Although four systems are illustrated in the presently described embodiment, the concepts disclosed here may be similarly applicable to an embodiment that includes more or less than four systems. In some embodiments, any of the systems described herein may be integrated into any of the other systems.

The water signal output system 202, the water system 206, the water consumer system 208, and the water supplier system 210 may be communicatively coupled to one another by a network 212 as described herein. In some embodiments, the network 212 may include a plurality of networks. In some embodiments, the network 212 may include any wireless and/or wired communications network that facilitates communication between the water signal output system 202, the water system 206, the water consumer system 208, and the water supplier system 210. For example, the one or more networks may include an Ethernet network, a cellular network, a computer network, the Internet, a wireless fidelity (Wi-Fi) network, a light fidelity (Li-Fi) network, a Bluetooth network, a radio frequency identification (RFID) network, a near-field communication (NFC) network, a laser-based network, and/or the like.

In some embodiments, the water signal output system 202 may include a handheld computing device, a smart phone, a tablet, a laptop computer, a desktop computer, a personal digital assistant (PDA), a smart watch, a wearable device, a biometric device, an implanted device, a camera, a video recorder, an audio recorder, a touchscreen, a computer server, a virtual server, an exchange platform server, a virtual machine, and/or a communications server. In some embodiments, the water signal output system 202 may include a plurality of user devices configured to communicate with one another and/or implement load-balancing techniques described herein. In some embodiments, the water signal output system 202 may be an electronic exchange such as a commodity exchange on which virtual instruments associated with water data may be exchanged between buyers and sellers. In some embodiments, the water signal output system 202 may be an output device on which a user can view water data and perform operations associated with water data.

The water signal output system 202 may include various elements of a computing environment as described herein (e.g., computing environment 300). For example, the water signal output system 202 may include a processing unit 214, a memory unit 216, an input/output (I/O) unit 218, and/or a communication unit 220. Each of the processing unit 214, the memory unit 216, the input/output (I/O) unit 218, and/or the communication unit 220 may include one or more subunits as described herein for performing any operation, technique, method, process, etc., described herein. The user 204 of the water signal output system may be a human or a computing device.

In some embodiments, the water system 206 may include a computing device such as a mainframe server, a content server, a communication server, a laptop computer, a desktop computer, a handheld computing device, a smart phone, a smart watch, a wearable device, a touch screen, a biometric device, a video processing device, an audio processing device, a virtual machine, a cloud-based computing solution and/or service, a point-of-sale terminal, a product code scanner, and/or the like. The water system 206 may include a plurality of computing devices configured to communicate with one another and/or implement load-balancing techniques described herein. In some embodiments, the water system 206 may include an optional water sensor for sensing attributes or properties associated with water, water data, etc. In some embodiments, water sensors may be included in or be communicatively coupled to any other systems, units, or sub-units described herein.

In some embodiments, the water system 206 may include various elements of a computing environment as described herein (e.g., computing environment 300). For example, the water system 206 may include a processing unit 222, a memory unit 224, an input/output (I/O) unit 226, and/or a communication unit 228. Each of the processing unit 222, the memory unit 224, the input/output (I/O) unit 226, and/or the communication unit 228 may include one or more subunits and/or other computing instances as described herein for performing any operation, technique, method, process, etc., described herein.

In some embodiments, the water consumer system 208 may include a computing device such as a mainframe server, a content server, a communication server, a laptop computer, a desktop computer, a handheld computing device, a smart phone, a smart watch, a wearable device, a touch screen, a biometric device, a video processing device, an audio processing device, a virtual machine, a cloud-based computing solution and/or service, and/or the like. The water consumer system 208 may include a plurality of computing devices configured to communicate with one another and/or implement load-balancing techniques described herein.

In some embodiments, the water consumer system 208 may include various elements of a computing environment as described herein (e.g., computing environment 300). For example, the water consumer system 208 may include a processing unit 230, a memory unit 232, an input/output (I/O) unit 234, and/or a communication unit 236. Each of the processing unit 230, the memory unit 232, the input/output (I/O) unit 234, and/or the communication unit 236 may include one or more subunits and/or other computing instances as described herein for performing any operation, technique, method, process, etc., described herein.

In some embodiments, the water consumer system 208 may be connected to or may comprise a water sensor 213. The water sensor 213 may determine water data associated with water supplied by or processed by or associated with the water consumer system 208. In some embodiments, the water consumer system 208 may be connected to or may comprise water infrastructure such as a water pipe 207. The water pipe 207 may represent any water infrastructure for transmitting, storing, or otherwise processing water.

In some embodiments, the water supplier system 210 may include a computing device such as a mainframe server, a content server, a communication server, a laptop computer, a desktop computer, a handheld computing device, a smart phone, a smart watch, a wearable device, a touch screen, a biometric device, a video processing device, an audio processing device, a virtual machine, a cloud-based computing solution and/or service, and/or the like. The water supplier system 210 may include a plurality of computing devices configured to communicate with one another and/or implement load-balancing techniques described herein.

In some embodiments, the water supplier system 210 may include various elements of a computing environment as described herein (e.g., computing environment 300). For example, the water supplier system 210 may include a processing unit 238, a memory unit 240, an input/output (I/O) unit 242, and/or a communication unit 244. Each of the processing unit 238, the memory unit 240, the input/output (I/O) unit 242, and/or the communication unit 244 may include one or more subunits and/or other computing instances as described herein for performing any operation, technique, method, process, etc., described herein.

In some embodiments, the water supplier system 210 may be connected to or may comprise a water sensor 211. The water sensor 211 may determine water data associated with water supplied by or processed by or associated with the water supplier system 210. In some embodiments, the water supplier system 210 may be connected to or may comprise water infrastructure such as a water pipe 209. The water pipe 209 may represent any water infrastructure for transmitting, storing, or otherwise processing water.

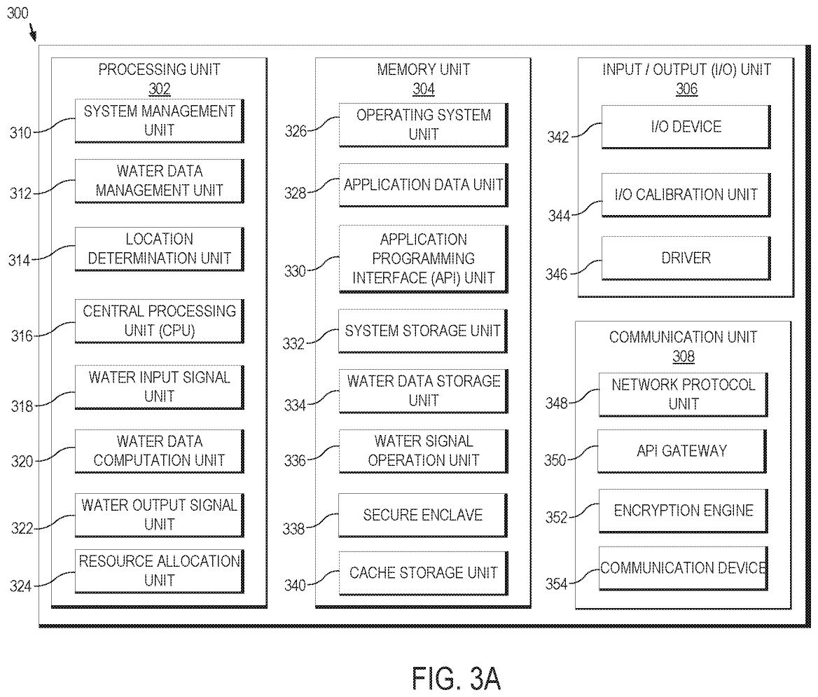

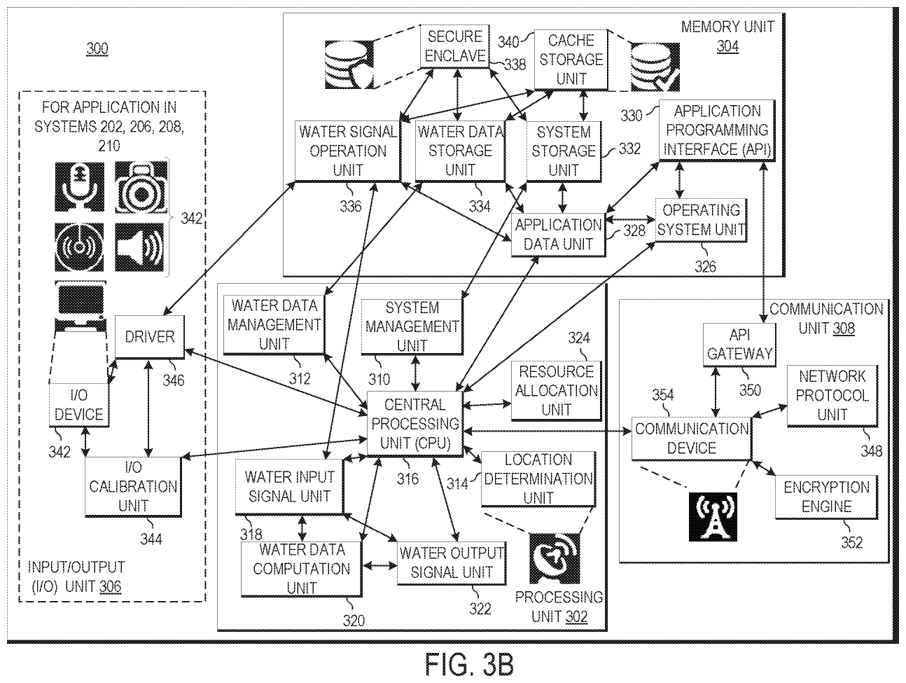

FIG. 3A and FIG. 3B illustrate functional and system diagrams, in accordance with a specific example embodiment, of a computing environment 300 for performing any operation, technique, method, process, etc., described herein. Specifically, FIG. 3A provides a functional block diagram of the computing environment 300, whereas FIG. 3B provides a detailed system diagram of the computing environment 300. In some embodiments, the various units and/or sub-units described in the figures of this disclosure are hardware. In other embodiments, the various units and/or sub-units described in the figures of this disclosure are software. In other embodiments, the various units and/or sub-units described in the figures of this disclosure are a combination of hardware and/or software.

As seen in FIG. 3A and FIG. 3B, the computing environment 300 may include a processing unit 302, a memory unit 304, an I/O unit 306, and a communication unit 308. Each of the processing unit 302, the memory unit 304, the I/O unit 306, and the communication unit 308 may include one or more subunits for performing any operation, technique, method, process, etc., described herein. Further, each unit and/or subunit of the computing environment 300 may be operatively and/or otherwise communicatively coupled with each other so as to perform any operation, technique, method, process, etc., described herein. The computing environment 300 including any of its units and/or subunits may include general hardware, specifically-purposed hardware, and/or software. The computing environment 300 may be located in any system or combination of systems described herein.

Importantly, the computing environment 300 of FIG. 3A and/or FIG. 3B may be included in one or more of the water signal output system 202, the water system 206, the water consumer system 208, and the water supplier system 210 of FIG. 2. Additionally, any units and/or subunits described herein with reference to the computing environment 300 of FIG. 3A and/or FIG. 3B may be included in one or more of the water signal output system 202, the water system 206, the water consumer system 208, and the water supplier system 210 of FIG. 2.

For example, the processing unit 302 of the computing environment 300 of FIG. 3A and/or FIG. 3B may be included in one or more of the processing units 214, 222, 230, 238 of FIG. 2. Similarly, the memory unit 304 of the computing environment 300 of FIG. 3A and/or FIG. 3B may be included in one or more of the memory units 216, 224, 232, 240 of FIG. 2. In some embodiments, the I/O unit 306 of the computing environment 300 of FIG. 3A and/or FIG. 3B may be included in one or more of the I/O units 218, 226, 234, 242 of FIG. 2. The communication unit 308 of the computing environment 300 of FIG. 3A and/or FIG. 3B may also be included in one or more of the communication units 220, 228, 236, 244 of FIG. 2.

The processing unit 302 may control one or more of the memory unit 304, the I/O unit 306, and the communication unit 308 of the computing environment 300, as well as any included subunits, elements, components, devices, and/or functions performed by the memory unit 304, the I/O unit 306, and the communication unit 308. The described sub-elements of the computing environment may also be included in similar fashion in any of the other units and/or devices included in the system 200 of FIG. 2. Additionally, any actions described herein as being performed by a processor or signal processor may be taken by the processing unit 302 of FIG. 3A and/or FIG. 3B alone and/or by the processing unit 302 in conjunction with one or more additional processors, units, subunits, elements, components, devices, and/or the like. Additionally, while one processing unit 302 may be shown in FIG. 3A and/or FIG. 3B, multiple processing units may be present and/or otherwise included in the computing environment 300 or elsewhere in the overall system (e.g., system 200 of FIG. 2). Thus, while instructions may be described as being executed by the processing unit 302 (and/or various subunits of the processing unit 302), the instructions may be executed simultaneously, serially, and/or otherwise by one or multiple processing units 302 on one or more devices.

In some embodiments, the processing unit 302 may be implemented as one or more computer or central processing unit (CPU) chips and/or graphical processing unit (GPU) chips and may include a hardware device capable of executing computer instructions. The processing unit 302 may execute instructions, codes, computer programs, and/or scripts. The instructions, codes, computer programs, and/or scripts may be received from and/or stored in the memory unit 304, the I/O unit 306, the communication unit 308, subunits and/or elements of the aforementioned units, other devices and/or computing environments, and/or the like.

In some embodiments, the processing unit 302 may include, among other elements, subunits such as a system management unit 310, a water data management unit 312, a location determination unit 314, a central processing unit (CPU) 316, a water input signal unit 318, a water data computation unit 320, a water signal output unit 322, and/or a resource allocation unit 324. Each of the aforementioned subunits of the processing unit 302 may be communicatively and/or otherwise operably coupled with each other.

The system management unit 310 may facilitate generation, modification, analysis, transmission, and/or presentation of data or water data associated with a system (e.g., a water supplier system 210, a water consumer system 208, a water signal output system 202, a water system 206, etc.). For example, the system management unit 310 may prompt a user or any other system described herein to register or authenticate by inputting authentication credentials, system data, water data, etc. The system management unit 310 may receive, process, analyze, organize, and/or otherwise transform any data received from the user and/or another computing element.

The water data management unit 312 may facilitate generation, modification, analysis, transmission, and/or presentation of water data. For example, the water data management unit 312 may control the audio-visual environment and/or appearance of water data during execution of various processes. In some embodiments, the water data management unit 312 may also interface with an external server and/or memory location.

The location determination unit 314 may facilitate detection, generation, modification, analysis, transmission, and/or presentation of location information associated with a system (e.g., a water supplier system 210, a water consumer system 208, a water signal output system 202, a water system 206, etc.). Location information may include global positioning system (GPS) coordinates, an Internet protocol (IP) address, a media access control (MAC) address, geolocation information, an address, a port number, a zip code, a server number, a proxy name and/or number, device information (e.g., a serial number), geographical region or area, network region or area, and/or the like. In some embodiments, the location determination unit 314 may include various sensors, a radar, and/or other specifically-purposed hardware elements for the location determination unit 314 to acquire, measure, and/or otherwise transform location information.

The CPU unit 316 may facilitate generation, modification, analysis, processing, transmission, and/or presentation of water data. In some embodiments, the CPU unit 316 may be utilized to render content for presentation on a computing device (e.g., the water signal output system 202 and/or the like). The CPU unit 316 may also include multiple CPUs and therefore may be configured to perform and/or execute multiple processes in parallel.

The water input signal unit 318 may receive and process water data from any of the systems (e.g., a water supplier system 210, a water consumer system 208, a water signal output system 202, a water system 206, etc.) described herein. The water data computation unit 320 may execute any of the operations associated with the water data to produce output data such as water indices. The water output signal unit 322 may execute any operations, including any graphic generating operations, to transmit water data and/or output signals carrying water data to any systems (e.g., a water supplier system 210, a water consumer system 208, a water signal output system 202, a water system 206, etc.) described herein. Graphic generating operations enable presentation of water data on output systems in communication with the water output signal unit 322. In some embodiments, the water input signal unit 318, the water data computation unit 320, and the water output signal unit 322 are specialized hardware and/or software units that are configured to execute one or more operations described herein.

The resource allocation unit 324 may facilitate the determination, monitoring, analysis, and/or allocation of computing resources throughout the computing environment 300 and/or other computing environments. For example, the computing environment may facilitate a high volume of (e.g., multiple) water data operations between a large number of users and water systems. As such, computing resources of the computing environment 300 utilized by the processing unit 302, the memory unit 304, the I/O unit 306, and/or the communication unit 308 (and/or any subunit of the aforementioned units) such as processing power, data storage space, network bandwidth, and/or the like may be in high demand at various times during operation. Accordingly, the resource allocation unit 324 may be configured to manage the allocation of various computing resources as they are required by particular units and/or subunits of the computing environment 300 and/or other computing environments. In some embodiments, the resource allocation unit 324 may include sensors and/or other specially-purposed hardware for monitoring performance of each unit and/or subunit of the computing environment 300, as well as hardware for responding to the computing resource needs of each unit and/or subunit. In some embodiments, the resource allocation unit 324 may utilize computing resources of a second computing environment separate and distinct from the computing environment 300 to facilitate a desired operation.

For example, the resource allocation unit 324 may determine a number of simultaneous water data operations. The resource allocation unit 324 may then determine that the number and type of water data operations. Based on this determination, the resource allocation unit 324 may determine an amount of additional computing resources (e.g., processing power, storage space of a particular non-transitory computer-readable memory medium, network bandwidth, and/or the like) required by the processing unit 302, the memory unit 304, the I/O unit 306, the communication unit 308, and/or any subunit of the aforementioned units for safe and efficient operation of the computing environment while supporting the number of simultaneous water data operations. The resource allocation unit 324 may then retrieve, transmit, control, allocate, and/or otherwise distribute determined amount(s) of computing resources to each element (e.g., unit and/or subunit) of the computing environment 300 and/or another computing environment.

In some embodiments, factors affecting the allocation of computing resources by the resource allocation unit 324 may include the number of ongoing water data operations and/or incoming requests for water data operations, a duration of time during which computing resources are required by one or more elements of the computing environment 300, and/or the like. In some embodiments, computing resources may be allocated to and/or distributed amongst a plurality of second computing environments included in the computing environment 300 based on one or more factors mentioned above. In some embodiments, the allocation of computing resources of the resource allocation unit 324 may include the resource allocation unit 324 flipping a switch, adjusting processing power, adjusting memory size, partitioning a memory element, transmitting data, controlling one or more input and/or output devices, modifying various communication protocols, and/or the like. In some embodiments, the resource allocation unit 324 may facilitate utilization of parallel processing techniques such as dedicating a plurality of CPUs included in the processing unit 302 for processing water data operations between multiple units and/or subunits of the computing environment 300 and/or other computing environments. Any reference to CPU may additionally include GPU, and vice versa.

In some embodiments, the memory unit 304 may be utilized for storing, recalling, receiving, transmitting, and/or accessing various files and/or data (e.g., water data) during operation of the computing environment 300. For example, the memory unit 304 may be utilized for storing recalling, and/or updating water data and/or the like. The memory unit 304 may include various types of data storage media such as solid state storage media, hard disk storage media, virtual storage media, and/or the like. The memory unit 302 may include dedicated hardware elements such as hard drives and/or servers, as well as software elements such as cloud-based storage drives. For example, the memory unit 304 may include various subunits such as an operating system unit 326, an application data unit 328, an application programming interface (API) unit 330, a system storage unit 332, a water data storage unit 334, a water signal operation unit 336, a secure enclave 338, and/or a cache storage unit 340. In some embodiments, the water signal operation unit 336 may be a specialized water signal operation unit that is customized with code for performing the various operations described herein.

The memory unit 304 and/or any of its subunits described herein may include random access memory (RAM), read only memory (ROM), and/or various forms of secondary storage. RAM may be used to store volatile data and/or to store instructions that may be executed by the processing unit 302. For example, the data stored may be a command, a current operating state of the computing environment 300, an intended operating state of the computing environment 300, and/or the like. As a further example, data stored in the memory unit 304 may include instructions related to various methods and/or functionalities described herein. ROM may be a non-volatile memory device that may have a smaller memory capacity than the memory capacity of a secondary storage. ROM may be used to store instructions and/or data that may be read during execution of computer instructions. In some embodiments, access to both RAM and ROM may be faster than access to secondary storage. Secondary storage may be comprised of one or more disk drives and/or tape drives and may be used for non-volatile storage of data or as an over-flow data storage device if RAM is not large enough to hold all working data. Secondary storage may be used to store programs that may be loaded into RAM when such programs are selected for execution. In some embodiments, the memory unit 304 may include one or more databases for storing any data such as water data described herein. Additionally or alternatively, one or more secondary databases located remotely from the computing environment 300 may be utilized and/or accessed by the memory unit 304.

The operating system unit 326 may facilitate deployment, storage, access, execution, and/or utilization of an operating system utilized by the computing environment 300 and/or any other computing environment described herein. In some embodiments, the operating system unit 326 may include various hardware and/or software elements that serve as a structural framework for the processing unit 302 to execute various operations described herein. The operating system unit 326 may further store various pieces of information and/or data associated with operation of the operating system and/or the computing environment 300 as a whole, such as a status of computing resources (e.g., processing power, memory availability, resource utilization, and/or the like), runtime information, modules to direct execution of operations described herein, user permissions, security credentials, and/or the like.

The application data unit 328 may facilitate deployment, storage, access, execution, and/or utilization of an application utilized by the computing environment 300 and/or any other computing environment described herein. For example, an application may be associated with any water system or water data described herein. As such, the application data unit 328 may store any information and/or data associated with the application. A user may use information included in the application data unit 328 to execute various operations described herein. The application data unit 328 may further store various pieces of data associated with operation of the application and/or the computing environment 300 as a whole, such as a status of computing resources (e.g., processing power, memory availability, resource utilization, and/or the like), runtime information, user interfaces, modules to direct execution of operations described herein, user permissions, security credentials, and/or the like.

The application programming interface (API) unit 330 may facilitate deployment, storage, access, execution, and/or utilization of information associated with APIs of the computing environment 300 and/or any other computing environment described herein. For example, the computing environment 300 may include one or more APIs for various devices, applications, units, subunits, elements, and/or other computing environments to communicate with each other and/or utilize the same data. Accordingly, the API unit 330 may include API databases comprising information that may be accessed and/or utilized by applications, units, subunits, elements, and/or operating systems of other devices and/or computing environments. In some embodiments, each API database may be associated with a customized physical circuit included in the memory unit 304 and/or the API unit 330. Additionally, each API database may be public and/or private, and so authentication credentials may be required to access information in an API database.

The system storage unit 332 may facilitate deployment, storage, access, and/or utilization of data associated with water systems by the computing environment 300 and/or any other computing environment described herein. In some embodiments, the system storage unit 332 may communicate with the system management unit 310 to receive and/or transmit water system data. Any water system data may be included in water data.

The water data storage unit 334 may facilitate deployment, storage, access, and/or utilization of water data by the computing environment 300 and/or any other computing environment described herein. For example, the water data storage unit 334 may store any water data described herein. In some embodiments, the water data storage unit 334 may communicate with the water data management unit 312 to receive and/or transmit water data.

The water signal operation unit 336 may facilitate deployment, storage, access, analysis, processing, transformation, modification, and/or utilization of water data by the computing environment 300 and/or any other computing environment described herein. The data stored in the water signal operation unit 336 may be utilized by the system management unit 310, the water data management unit 312, the CPU unit 316, the water input signal unit 318, the water data computation unit 320, and/or the water output signal unit 322 to perform various operations described herein.

The secure enclave 338 may facilitate secure storage of data. In some embodiments, the secure enclave 338 may include a partitioned portion of storage media included in the memory unit 304 that is protected by various security measures. For example, the secure enclave 338 may be hardware secured. In other embodiments, the secure enclave 338 may include one or more firewalls, encryption mechanisms, and/or other security-based protocols. Authentication credentials of a user or system may be required prior to providing access to data stored within the secure enclave 338. Data stored in the secure enclave 338 may include any water data described herein.

The cache storage unit 340 may facilitate short-term deployment, storage, access, analysis, and/or utilization of data. For example, the cache storage unit 240 may be utilized for storing water data. In some embodiments, the cache storage unit 340 may serve as a short-term storage location for data so that the data stored in the cache storage unit 340 may be accessed quickly. In some embodiments, the cache storage unit 340 may include RAM and/or other storage media types for quick recall of stored data. The cache storage unit 340 may include a partitioned portion of storage media included in the memory unit 304.

The I/O unit 306 may include hardware and/or software elements for the computing environment 300 to receive, transmit, and/or present data useful for performing various operations described herein. For example, elements of the I/O unit 306 may be used to receive user input from a user via a user device, generate graphical representations of water data, present user interfaces and display water data to users on the user interface, and/or the like. The user interfaces may be configured and adjusted for the display device. In this manner, the computing environment 300 may use the I/O unit 306 to interface with a human (or nonhuman) user. As described herein, the I/O unit 306 may include subunits such as an I/O device 342, an I/O calibration unit 344, and/or a software driver 346. The software driver 346 may comprise a display driver such as a graphic driver.

The I/O device 342 may facilitate the receipt, transmission, processing, presentation, display, input, and/or output of data such as water data as a result of executed processes described herein. In some embodiments, the I/O device 342 may include a plurality of I/O devices. In some embodiments, the I/O device 342 may include one or more elements of a user device, a computing system, a server, a remote or local terminal, and/or a similar device. As such, the I/O device 342 may include a variety of elements for a user to interface with the computing environment 300. For example, the I/O device 342 may include a keyboard, a touchscreen, a button, a sensor, a biometric scanner, a laser, a microphone, a camera, a barcode scanner, a cash register, a point-of-sale terminal, and/or another element for receiving and/or collecting input from a user. Additionally and/or alternatively, the I/O device 342 may include a display, a screen, a sensor, a vibration mechanism, a light emitting diode (LED), a speaker, a scanner, and/or another element for presenting and/or otherwise outputting data to a user or to another system. In some embodiments, the I/O device 342 may communicate with one or more elements of the processing unit 302 and/or the memory unit 204 to execute operations described herein.

The I/O calibration unit 344 may facilitate the calibration of the I/O device 342. For example, the I/O calibration unit 344 may detect and/or determine one or more settings of the I/O device 342, and then adjust and/or modify settings so that the I/O device 342 may operate more efficiently. For example, the I/O calibration unit 344 may calibrate display of water data on the I/O device 342 based on display and system settings of the I/O device 342.

In some embodiments, the I/O calibration unit 344 may utilize a driver 346 (or multiple drivers) to calibrate the I/O device 342. For example, the driver 346 may include software that is to be installed by the I/O calibration unit 344 so that an element of the computing environment 300 (or an element of another computing environment) may recognize and/or integrate with the I/O device 342 for the various operations described herein.

The communication unit 308 may facilitate establishment, maintenance, monitoring, and/or termination of communications between the computing environment 300 and other computing environments, third party server systems, and/or the like. In some embodiments, the communication unit 308 may also be referred to as a signal interface. The communication unit 234 may facilitate communication between various elements (e.g., units and/or subunits) of the computing environment 300. In some embodiments, the communication unit 234 may include a network protocol unit 348, an API gateway 350, an encryption engine 352, and/or a communication device 354. The communication unit 234 may include hardware and/or software elements.

The network protocol unit 348 may facilitate establishment, maintenance, and/or termination of a communication connection for the computing environment 300 by way of a network. For example, the network protocol unit 348 may detect and/or define a communication protocol required by a particular network and/or network type. Communication protocols utilized by the network protocol unit 348 may include Wi-Fi protocols, Li-Fi protocols, cellular data network protocols, Bluetooth® protocols, WiMAX protocols, Ethernet protocols, powerline communication (PLC) protocols, and/or the like. In some embodiments, facilitation of communication for the computing environment 300 may include transforming and/or translating data from being compatible with a first communication protocol (e.g., associated with a first system such as system 208 or 210) to being compatible with a second communication protocol (e.g., associated with a second system such as system 206 or 202). In some embodiments, the network protocol unit 348 may determine and/or monitor an amount of data traffic to consequently determine which particular network protocol is to be used for establishing a secure communication connection, transmitting data, and/or performing operations as described herein.

The API gateway 350 may facilitate other devices and/or computing environments to access the API unit 330 of the memory unit 304 of the computing environment 300. For example, a user device (e.g., system 202 or 206 of FIG. 2) may access the API unit 330 of the computing environment 300 via the API gateway 350. In some embodiments, the API gateway 350 may be required to validate user credentials and/or system credentials prior to providing access to the API unit 330 to a user and/or a system. The API gateway 350 may include instructions for the computing environment 300 to communicate with another device and/or between elements of the computing environment 300.

The encryption engine 352 may facilitate translation, encryption, encoding, decryption, and/or decoding of information received, transmitted, and/or stored by the computing environment 300. Using the encryption engine, each transmission of data may be encrypted, encoded, and/or translated for security reasons, and any received data may be encrypted, encoded, and/or translated prior to its processing and/or storage. In some embodiments, the encryption engine 352 may generate an encryption key, an encoding key, a translation key, and/or the like, which may be transmitted along with any data content. Any communication from one water system to another water system may need to be authenticated and/or encrypted.

The communication device 354 may include a variety of hardware and/or software specifically purposed to communication for the computing environment 300. In some embodiments, the communication device 354 may include one or more radio transceivers, chips, analog front end (AFE) units, antennas, processing units, memory, other logic, and/or other components to implement communication protocols (wired or wireless) and related functionality for facilitating communication for the computing environment 300. Additionally and/or alternatively, the communication device 354 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes.

In summary, the presently disclosed embodiments include systems configured to receive water data from disparate and disconnected water systems (e.g., utilities, water providers, etc.), assimilate the water data, perform calculations on the water data, and produce useful water data such as a water price that is easily understood and can be used for many purposes.

The embodiments described in this disclosure have many applications. One application is in the field of electronic commerce. The present disclosure is however not limited to this application. Water is an important component of inflation and it has outperformed inflation consistently. Water can be used as a hedge against inflation rates in the U.S. and elsewhere. There is no listed water price in the world at present such that a user can use the water price as a tool for investment or risk offsetting, or as an infrastructure tool. Embodiments of the present disclosure address this issue by providing a water index and enabling various operations associated with this water index.

The water data described herein can be used to trade water or virtual water-related instruments. The trading of water or virtual water-related instruments may be used as a hedge against inflation rates in the U.S. and elsewhere. The water data described herein may be a current (i.e., spot) or future price of water. Instruments (e.g., virtual electronic trading instruments) may be created by market makers based on the water data. Instruments based on the water data may be used for short and long-terms trades, arbitrages between various regions, relative trades such as water versus beef, corn, oil, etc. For example, a relative trade may be buying long a water-related instrument and simultaneously selling short a corn-related instrument. An instrument as described herein may be the actual commodity, a fund such as an exchange traded fund or a mutual fund based on the current, past, or future price of the commodity or based on entities associated with the commodity (e.g., water supplying entities, industrial or agricultural water consuming entities, etc.), a future, an option, any other derivative of any instrument, etc. The instruments may be associated with bid and offer quotes. For example, a future or an option may be associated with a bid price, an ask price, a water unit size (e.g., 1 million gallons) and a water unit value (e.g., a certain price). The future or option may also be associated with an expiry date. A trader may go long or short prior to expiry and hold the instrument until expiry or trade it away prior to expiry. The trader may incur a profit or loss on a trade or if the user holds the instrument until expiry. An exchange on which the instrument is traded may determine an amount of funds and other requirements for a user to be able to trade these instruments. In some embodiments, a water credit trading system is provided. Water credits may be traded on the water credit trading system. A water credit may represent a certain volume of past, present, or future water.

Embodiments described herein can help level price disparities of water around the world. Embodiments described herein can be used as a platform to trade water and to create a market-based price that creates liquidity and transparency in the water market. Embodiments described herein can also be used by users of water to minimize their risk. Embodiments described herein can also create a more accurate and understandable method of financing water infrastructure projects allowing water to be delivered where it is needed most at a defined price. Embodiments described herein can also be used to hedge against inflation and hedge against other asset classes. In some embodiments, a water index or water price may be listed on an exchange or platform. Users may use a broker, such as an electronic broker, to buy long, sell long, sell short, buy to cover, or otherwise trade virtual electronic instruments associated with the water index or price on the exchange or platform. The virtual electronic instruments may be used as hedging instruments, investments, speculative tools, etc.

In some embodiments, water data, water indices, water signal systems, and/or other water metrics, etc., may be used in any type of operation. An operation may include any transaction, any instrument, any transaction associated with an instrument, etc. An example transaction or instrument includes an index, future, exchange traded fund, a swap transaction, swap option, commodity swap, commodity option, cap transaction, floor transaction, collar transaction, foreign exchange transaction, currency swap, currency option, credit protection transaction, credit swap, credit default swap, credit default option, total return swap, credit spread transaction, repurchase transaction, reverse repurchase transaction, buy/sell-back transaction, weather index transaction or forward purchase or sale of a commodity, including any option with respect to any of these transactions, any combinations of instruments or instruments, or the like. The list of instruments or transactions is not limited to this list and may include any other instrument or transaction, or combination thereof, including any forward, swap, future, option or other derivative, or debt securities or other debt instruments, economic indices or measures of economic risk or value, or other benchmarks against which payments or deliveries are to be made. Any operation may include any combination of one or more transactions and/or instruments described herein.

In some embodiments, a method is provided for communicating with disparate water-related input signal systems and generating water-related output signals, the communicating and generating being necessarily rooted in computing technology. The method comprises: establishing, using one or more computing device processors, a first connection to a first water-related input signal system, the first water-related input signal system being associated with a first water supplier, the first water supplier being associated with a first water pipe; receiving, using the one or more computing device processors, a first input signal on the first connection, the first input signal comprising first water data; establishing, using the one or more computing device processors, a second connection to a second water-related input signal system, the second water-related input signal system being associated with a second water supplier, the second water supplier being associated with a second water pipe; receiving, using the one or more computing device processors, a second input signal on the second connection, the second input signal comprising second water data; establishing, using the one or more computing device processors, a third connection to a computing device; transmitting, using the one or more computing device processors, an output signal to the computing device, the output signal comprising a water index; and determining, using the one or more computing device processors, a first computation technique of the water index, the first computation technique of the water index being determined at a previous time; determining, using the one or more computing device processors, a triggering event for modifying the first computation technique; modifying, using the one or more computing device processors, based on the triggering event, at least one component of the first computation technique; determining, using the one or more computing device processors, a first supply volume associated with the first water supplier; modifying, using the one or more computing device processors, the first water data based on the first water supply volume associated with the first water supplier; determining, using the one or more computing device processors, a second supply volume associated with the second water supplier; modifying, using the one or more computing device processors, the second water data based on the second water supply volume associated with the second water supplier; determining, using the one or more computing device processors, a water use metric; modifying, using the one or more computing device processors, the water use metric using a consumable water weighting technique; and computing, using the one or more computing device processors, using the modified first computation technique, the water index based on the modified first water data, the modified second water data, and the modified water use metric. In some embodiments, the term “volume” (e.g., water supply volume, water consumption volume, etc.) can be replaced with any other water metric, water data, water system data or metric, water application data or metric, etc.

In some embodiments, the consumable water weighting technique comprises applying a consumable water weighting factor to the water use metric. In some embodiments, the consumable water weighting factor is associated with electro-thermal cooling associated with water.

In some embodiments, the water use metric comprises a water consumption volume. In other embodiments, the water use metric may comprise any other water use metrics including, but not limited to, water supply volume, water supply and/or consumption temperature and/or pressure and/or duration, water pipe parameters for supply and/or consumption and/or transmission and/or storage, water transmission or reception volume and/or temperature and/or pressure and/or duration, water storage volume and/or temperature and/or pressure and/or duration, etc. In some embodiments, the water use metric may be associated with any water, water system, water data, water application, etc., described herein. In some embodiments, the water use metric may be based on or comprise any water data, water application, etc., described herein.

In some embodiments, determining the triggering event comprises determining whether the first water data or the second water data was used in a previous computation of the water index. In some embodiments, determining the triggering event comprises determining whether the first water data or the second water data was not used in a previous computation of the water index. In some embodiments, determining the triggering event comprises determining whether third water data that was used in a previous computation of the water index is not received from a third water-based input signal system, the third water-based input signal system associated with a third supplier. In some embodiments, determining the triggering event comprises determining a change in the first water data or the second water data that was used in a previous computation of the water index.

In some embodiments, the first water data comprises the first supply volume and the second water data comprises the second supply volume. In some embodiments, the change in the first water data comprises a change in the first supply volume, and the change in the second water data comprises a change in the second supply volume. In some embodiments, the change in the first supply volume of the second supply volume is equal to greater than a certain absolute or relative level. In some embodiments, determining the triggering event comprises determining a change event associated with the first water supplier or the second water supplier. In some embodiments, the first water supplier, the second water supplier, and the water use metric are associated with the same region. In some embodiments, the first water supplier, the second water supplier, and the water use metric are associated with the same region and a same period of time.

In some embodiments, a method is provided for communicating with disparate water-related input signal systems and generating water-related output signals, the communicating and generating being necessarily rooted in computing technology. The method comprises: establishing, using one or more computing device processors, a first connection to a first water-related input signal system, the first water-related input signal system being associated with a first water supplier, the first water supplier being associated with a first water pipe; receiving, using the one or more computing device processors, a first input signal on the first connection, the first input signal comprising first water data; establishing, using the one or more computing device processors, a second connection to a second water-related input signal system, the second water-related input signal system being associated with a second water supplier, the second water supplier being associated with a second water pipe; receiving, using the one or more computing device processors, a second input signal on the second connection, the second input signal comprising second water data; establishing, using the one or more computing device processors, a third connection to a computing device; transmitting, using the one or more computing device processors, an output signal to the computing device, the output signal comprising a water index; determining, using the one or more computing device processors, a first supply volume associated with the first water supplier; modifying, using the one or more computing device processors, the first water data based on the first water supply volume associated with the first water supplier; determining, using the one or more computing device processors, a second supply volume associated with the second water supplier; modifying, using the one or more computing device processors, the second water data based on the second water supply volume associated with the second water supplier; determining, using the one or more computing device processors, a water use metric; modifying, using the one or more computing device processors, the water use metric using a consumable water weighting technique, the consumable water weighting technique used for removing at least some unusable water volume or waste water volume from the water use metric; and computing, using the one or more computing device processors, the water index based on the modified first water data, the modified second water data, and the modified water use metric.

In some embodiments, the first water supply volume comprises a first relative water supply volume associated with the first water supplier with respect to total water supply volume in a region associated with the first water supplier, and wherein the second water supply volume comprises a second relative water supply volume associated with the second water supplier with respect to the total water supply volume in the region, the region also being associated with the second water supplier.

In some embodiments, the first water supply volume is modified based on the first water data, and the second water supply volume is modified based on the second water data. In some embodiments, the first water data is modified based on third water data associated with first other water suppliers in a region associated with the first water supplier and the first other water suppliers, and the second water data is modified based on fourth water data associated with the first other suppliers. In some embodiments, the first water supplier or the second water supplier comprises at least two water suppliers.

In some embodiments, the first water data is modified based on the second water data, or wherein the second water data is modified based on the first water data. In some embodiments, the consumable water weighting technique comprises applying a consumable water weighting factor to the water use metric. In some embodiments, the consumable water weighting factor is comprised in at least one of the first water data or the second water data.

In some embodiments, a method is provided for communicating with disparate water-related input signal systems and generating water-related output signals, the communicating and generating being necessarily rooted in computing technology. The method comprises: establishing, using one or more computing device processors, a first connection to a first water-related input signal system, the first water-related input signal system being associated with a first water supplier, the first water supplier being associated with a first water pipe; receiving, using the one or more computing device processors, a first input signal on the first connection, the first input signal comprising first water data; establishing, using the one or more computing device processors, a second connection to a second water-related input signal system, the second water-related input signal system being associated with a second water supplier, the second water supplier being associated with a second water pipe; receiving, using the one or more computing device processors, a second input signal on the second connection, the second input signal comprising second water data; establishing, using the one or more computing device processors, a third connection to a computing device; transmitting, using the one or more computing device processors, an output signal to the computing device, the output signal comprising a water index;

determining, using the one or more computing device processors, the first water data associated with the first water supplier; determining, using the one or more computing device processors, the second water data associated with the second water supplier; determining, using the one or more computing device processors, a water use metric; and computing, using the one or more computing device processors, the water index based on the first water data, the second water data, and the water use metric.

In some embodiments, the water use metric is comprised in at least one of the first water data or the second water data. In some embodiments, the water use metric is received on an third input signal separately from the first input signal and the second input signal. In some embodiments, the water use metric is associated with a region. In some embodiments, the first water data or the second water data comprises average water data.

In some embodiments, the method further comprises determining a location of at least one of the first water-related input signal system or the second water-related input signal system. In some embodiments, the first water-related input signal system is located in a different region compared to the second water-related input signal system. In some embodiments, the first water supplier is located in a different region compared to the second water supplier. In some embodiments, the first water-related input signal system is located in the same region compared to the second water-related input signal system.

In some embodiments, the first water supplier is located in the same region compared to the second water supplier. In some embodiments, the first water pipe is associated with a first width and wherein the second water pipe is associated with a first width. In some embodiments, the first water pipe is associated with a first width and wherein the second water pipe is associated with a second width. In some embodiments, a width of the first water pipe or the second water pipe is associated with a use of water flowing through the pipe. In some embodiments, the first water-related input signal system comprises a water supplier system, and the second water-related input signal system comprises a water consumer system.

In some embodiments, the first water-related input signal system comprises a first water supplier system, and wherein the second water-related input signal system comprises a second water supplier system. In some embodiments, the computing device comprises an exchange server or platform. In some embodiments, a graphical presentation of the water data is viewable and configurable on the computing device. In some embodiments, the water index comprises an agricultural water index. In some embodiments, the first water supplier and the second water supplier supply at least a certain volume of water for agricultural use. In some embodiments, the water index comprises an industrial water index. In some embodiments, the first water supplier and the second water supplier supply at least a certain volume of water for industrial use. In some embodiments, the water index comprises a residential water index. In some embodiments, the first water supplier and the second water supplier supply at least a certain volume of water for residential use.

In some embodiments, the water index comprises a global water index. In some embodiments, the water index comprises a product-specific index. In some embodiments, the water index comprises a cross-product index. In some embodiments, the water index comprises the water index being relative an index associated with a commodity other than or unrelated to water (e.g., energy). In some embodiments the water index comprises the water index being relative an index associated with a commodity comprising or related to water.

In some embodiments, the first water-related input signal system is authenticated. In some embodiments, the first water supplier comprises a utilities provider. In some embodiments, an exchangeable electronic instrument is created based on the water index. In some embodiments, the exchangeable electronic instrument is exchanged on an exchange platform.

In some embodiments, the water index is based on a type of water. In some embodiments, the water index is based on a type of water-related application.

In some embodiments, a non-transitory computer-readable medium is provided for communicating with disparate water-related input signal systems and generating water-related output signals, the communicating and generating being necessarily rooted in computing technology. The non-transitory computer-readable medium comprises code configured for: establishing, using one or more computing device processors, a first connection to a first water-related input signal system, the first water-related input signal system being associated with a first water supplier, the first water supplier being associated with a first water pipe; receiving, using the one or more computing device processors, a first input signal on the first connection, the first input signal comprising first water data; establishing, using the one or more computing device processors, a second connection to a second water-related input signal system, the second water-related input signal system being associated with a second water supplier, the second water supplier being associated with a second water pipe; receiving, using the one or more computing device processors, a second input signal on the second connection, the second input signal comprising second water data; establishing, using the one or more computing device processors, a third connection to a computing device; transmitting, using the one or more computing device processors, an output signal to the computing device, the output signal comprising a water index;

determining, using the one or more computing device processors, the first water data associated with the first water supplier; determining, using the one or more computing device processors, the second water data associated with the second water supplier; determining, using the one or more computing device processors, water use metric data; and computing, using the one or more computing device processors, the water index based on the first water data, the second water data, and the water use metric data.

In some embodiments, a method is provided for electronically exchanging water-based signals, the exchanging being necessarily rooted in computing technology. The method comprises: establishing, using one or more computing device processors, a first connection to a first input signal system; receiving, using the one or more computing device processors, a first input signal on the first connection, the first input signal comprising a request to transmit a first water-based virtual instrument, the request being associated with at least one transmission condition, the first water-based virtual instrument being associated with first water data; establishing, using the one or more computing device processors, a second connection to a second input signal system; receiving, using the one or more computing device processors, a second input signal on the second connection, the second input signal comprising a request to receive a second water-based virtual instrument, the request being associated with at least one receipt condition, the second water-based virtual instrument being associated with second water data; in response to determining the at least one transmission condition is met, causing transmission of the first water-based virtual instrument; and in response to determining the at least one receipt condition is met, causing receipt of the second water-based virtual instrument.

In some embodiments, the first water-based virtual instrument is equivalent to the second water-based virtual instrument. In some embodiments, the first water-based virtual instrument or the second water-based virtual instrument is transmitted from a first storage to a second storage. In some embodiments, the first water-based virtual instrument is different from the second water-based virtual instrument. In some embodiments, the first water-based virtual instrument or the second water-based virtual instrument is associated with a present or future consumption of water. In some embodiments, the first water-based virtual instrument or the second water-based virtual instrument is associated with a present or future supply of water. In some embodiments, the first water-based virtual instrument or the second water-based virtual instrument is associated with a volume of water.

In some embodiments, a non-transitory computer-readable medium is provided for communicating with disparate water-related input signal systems and generating water-related output signals, the communicating and generating being necessarily rooted in computing technology. The non-transitory computer-readable medium comprises code configured for: establishing, using one or more computing device processors, a first connection to a first water-related input signal system, the first input signal system being associated with a first water supplier, the first water supplier being associated with a first water pipe; receiving, using the one or more computing device processors, a first input signal on the first connection, the first input signal comprising first water data; establishing, using the one or more computing device processors, a second connection to a second water-related input signal system, the second input signal system being associated with a second water supplier, the second water supplier being associated with a second water pipe; receiving, using the one or more computing device processors, a second input signal on the second connection, the second input signal comprising second water data; establishing, using the one or more computing device processors, a third connection to a computing device; transmitting, using the one or more computing device processors, an output signal to the computing device, the output signal comprising a water index; determining, using the one or more computing device processors, the first water data associated with the first water supplier; determining, using the one or more computing device processors, the second water data associated with the second water supplier; determining, using the one or more computing device processors, water use metric data; and computing, using the one or more computing device processors, the water index based on the first water data, the second water data, and the water use metric data, wherein one or more parameters of the computing device (e.g., a user interface of the computing device) are configured to display a graphical representation of the water index. In some embodiments, the water use metric data comprises water consumption data.

In some embodiments, a method is provided for communicating with disparate water-related input signal systems and generating water-related output signals, the communicating and generating being necessarily rooted in computing technology. The method comprises: establishing, using one or more computing device processors, a first connection to a first water-related input signal system, the first water-related input signal system being associated with a first water supplier, the first water supplier being associated with a first water pipe; receiving, using the one or more computing device processors, a first input signal on the first connection, the first input signal comprising first water data; establishing, using the one or more computing device processors, a second connection to a second water-related input signal system, the second water-related input signal system being associated with a second water supplier, the second water supplier being associated with a second water pipe; receiving, using the one or more computing device processors, a second input signal on the second connection, the second input signal comprising second water data; establishing, using the one or more computing device processors, a third connection to a computing device; transmitting, using the one or more computing device processors, an output signal to the computing device, the output signal comprising a water index; determining, using the one or more computing device processors, the first water data associated with the first water supplier; determining, using the one or more computing device processors, the second water data associated with the second water supplier; and computing, using the one or more computing device processors, the water index based on the first water data and the second water data.

In some embodiments, input signals are received from more than two water-related input signal systems, the input signals comprises water data associated with the more than two water-related input signal systems.

In some embodiments, input signals are received from more than two water-related input signal systems, the input signals comprises water data associated with the more than two water-related input signal systems.

In some embodiments, a method is provided for communicating with disparate water-related input signal systems and generating water-related output signals, the communicating and generating being necessarily rooted in computing technology. The method comprises: establishing, using one or more computing device processors, a first connection to a first water-related input signal system, the first water-related input signal system being associated with a first water supplier, the first water supplier being associated with a first water pipe; receiving, using the one or more computing device processors, a first input signal on the first connection, the first input signal comprising first water data; establishing, using the one or more computing device processors, a second connection to a computing device; transmitting, using the one or more computing device processors, an output signal to the computing device, the output signal comprising a water index; determining, using the one or more computing device processors, the first water data associated with the first water supplier; and computing, using the one or more computing device processors, the water index based on the first water data.

In some embodiments, the first water-related input signal system or the second water-related input signal system comprises multiple water-related input signal systems, and the first water data or the second water data comprises water data received from the multiple water-related input signal systems.

In some embodiments, the method comprises determining, using the one or more computing device processors, a water use metric, wherein the water index is computed based on the first water data and the water use metric.

In some embodiments, the water use metric comprises multiple water use metrics received from multiple water systems.

In some embodiments, the modifying, based on the triggering event, the at least one component of the first computation technique comprises dynamically modifying, based on the triggering event, the at least one component of the first computation technique. For example, the modifying is executed immediately upon receiving data associated with the triggering event.

In some embodiments, the modifying the first water data comprises dynamically modifying the first water data, and wherein the modifying the second water data comprises dynamically modifying the second water data. For example, the modifying the first water data and/or the second water data is executed immediately upon receiving the first water data and/or the second water data.

In some embodiments, the modifying the water use metric using the consumable water weighting technique comprises dynamically modifying the water use metric using the consumable water weighting technique. For example, the modifying the water use metric is executed immediately upon receiving the water use metric and/or data associated with the consumable water weighting technique.

In some embodiments, the consumable water weighting factor is associated with electro-thermal cooling associated with water, wherein at least a portion of the water, received from a water source system, at a system that performs the electro-thermal cooling of the water, is returned to the water source system.

In some embodiments, the portion of the water returned to the water source system is at a higher temperature compared to the water received from the water source system.

In some embodiments, the portion of the water comprises at least 96% of the water.

In some embodiments, the portion of the water comprises a substantial portion of the water, but not all the water. In other embodiments, the portion of the water comprises all the received water.

In some embodiments, input signals are received from more than two water-related input signal systems, the input signals comprise water data associated with the more than two water-related input signal systems, wherein the more than two water-related input signal systems are associated more than two water suppliers.

In some embodiments, input signals are received from more than two water-related input signal systems, the input signals comprise water data associated with the more than two water-related input signal systems, wherein the more than two water-related input signal systems are associated more than two water suppliers.

In some embodiments, the water use metric comprises multiple water use metrics, wherein the multiple water use metrics are received from multiple water systems.

In some embodiments, the one or more computing device processors are located in one or more water systems.

In some embodiments, the one or more water systems comprises a water supply system, a water consumption system, a water transmission or receipt system, or a water processing system.

In some embodiments, digital signals obtained from the following may be transmitted to one or more servers: level of snow on mountain(s) in a region, level of river(s) in a region, level of dam(s) in a region, rainfall and other precipitation measurement in a region, cloud cover in a region, temperature associated with a region or water source, humidity associated with a region, etc. This list of signals is not limited to any particular signals or data and may include any other signals or data disclosed or not disclosed herein. The digital signals may be obtained using one or more moisture-related sensors, actuators, and/or other measuring hardware and/or software, etc. The signals may be stored (i.e., non-transitory) and transmitted periodically to the one or more servers, or the signals may be transmitted dynamically upon request by the one or more servers or one or more computing devices in communication with the one or more servers. The signals (or water data associated with these signals) may be transmitted over networks and may feed into software programs and/or databases. The water data may be used by water users and water asset managers (e.g., utilities managers, dam owners, water bank owners, etc.) to apply their water strategy according to their current or future water needs. In some embodiments, the water data may be used to purchase (or store) an amount or volume of physical water. In some embodiments, the purchase may be made via contracts or other electronic documentation showing specific water delivery times and delivery routes.

In some embodiments, the data or signals from the various sources may be processed and/or smoothed using one or more computational and/or smoothing techniques before the data is processed for use on any exchange platform described herein. The computed data may represent a water index or may be used in another computation to produce a water index. In some embodiments, the water index may be any type of water data, including water price, water volume, or other water data indicator, etc. In some embodiments, the water index may refer to both a price (e.g., in one or more currencies) and a volume (e.g., gallons, acre feet, etc.). The water index may be used as the basis of one or more exchangeable electronic or digital products (or instruments) (e.g., associated with a particular region such as California) that may trade on an exchange platform. In some embodiments, the water index itself cannot be exchanged on the exchange platform. The digital instruments may be exchanged by one or more users or entities or subscribers on the exchange platform via their computing devices. Water indexes may be similarly generated for other regions (e.g., cities, states, countries, etc.). In some embodiments, users may use the water index as a reference tool for determining or estimating water-related data (e.g., price, water supply volumes, water consumption volumes, etc.). Electronic derivatives based on the water index (e.g., forwards, futures, options, etc.) may be used to hedge and enhance any water user's or accumulator's needs and positions. These electronic derivatives may also be exchangeable digital or electronic products. Any exchangeable digital or electronic products or instruments described herein can enhance water delivery times and dates using infrastructure such as canals, pipes, aqueducts, etc.

As an example, if a large irrigator (who is in need of water to irrigate crops at the end of summer) buys an exchangeable digital product (e.g., a future based on the water index) because the irrigator is anticipating dry and hot conditions at the end of summer, the irrigator is hedged against possible higher water prices in the summer because the value of the future will go up as the price goes up. Upon delivery time at the end of the summer, the irrigator will sell the purchased future and use the profit associated with the sale to purchase water for delivery at the higher price. The release of water to the irrigator may be recorded as a signal sent to any of the servers or computing devices described herein. This signal may affect the status of water supply in a particular region which may affect the flow of water (e.g., through canals, aqueducts, pipes, etc.) in a particular region. Since the irrigator purchased the future, the irrigator did not experience a financial loss by paying a higher price for the purchase of water for delivery. If the irrigator did not have any hedge in place, the irrigator would have to continually buy water (e.g., in the water spot market) to ensure adequate water supply for delivery and the irrigator's water deliveries would end up being sporadic. Therefore, embodiments described herein effect water management associated with water supply and consumption and will change the actual physical flow of water (e.g., through canals, aqueducts, pipes, etc.) in a particular region or between particular regions.

As used herein, a conduit may refer to any type of channel, pipe, passageway, tube, trough, gutter, canal, sewer, vein, pass, aqueduct, carrier, artery, medium, runway, tunnel, watercourse, way, gully, furrow, ditch, main, duct, etc., whether open or closed, for conveying water or fluid from one location to another. In summary, various water level or environmental readings are obtained using various monitoring systems or sensors. These readings enable water users to decide on buying and selling water. Collective buying/selling pressure associated with water users makes the water price move. These moves may be recorded and processed using a smoothing operation executed by a computing system. The smoothed prices may be fed, on a volume-weighted basis, onto an exchange platform where exchange operations or transactions associated with exchangeable instruments based on the water price or index may occur.

While various implementations in accordance with the disclosed principles have been described above, it should be understood that they have been presented by way of example only, and are not limiting. Thus, the breadth and scope of the implementations should not be limited by any of the described implementations, but should be defined only in accordance with the claims and their equivalents issuing from this disclosure. Furthermore, the above advantages and features are provided in described implementations, but shall not limit the application of such issued claims to processes and structures accomplishing any or all of the above advantages.

Various terms used herein have special meanings within the present technical field. Whether a particular term should be construed as such a “term of art,” depends on the context in which that term is used. “Connected to,” “in communication with,” “communicably linked to,” “in communicable range of” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the implementations set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any implementations in this disclosure. Neither is the “Summary” to be considered as a characterization of the implementations set forth in issued claims. Furthermore, any reference in this disclosure to “implementation” in the singular should not be used to argue that there is only a single point of novelty in this disclosure. Multiple implementations may be set forth according to the limitations of the multiple claims issuing from this disclosure, and such claims accordingly define the implementations, and their equivalents, that are protected thereby. In all instances, the scope of such claims shall be considered on their own merits in light of this disclosure, but should not be constrained by the headings herein.

Lastly, although similar reference numbers may be used to refer to similar elements for convenience, it can be appreciated that each of the various example implementations may be considered distinct variations.

1. A method for communicating with disparate water-related input signal systems and generating water-related output signals, the method comprising:
establishing, using one or more computing device processors, a first connection to a first water-related input signal system associated with a first water conduit;
receiving, using the one or more computing device processors, a first input signal on the first connection, the first input signal comprising first water data;
establishing, using the one or more computing device processors, a second connection to a second water-related input signal system, the second input signal system being associated with a second water conduit;
receiving, using the one or more computing device processors, a second input signal on the second connection, the second input signal comprising second water data;
establishing, using the one or more computing device processors, a third connection to a computing device;
transmitting, using the one or more computing device processors, an output signal to the computing device, the output signal comprising a water index;
determining, using the one or more computing device processors, the first water data associated with the first water conduit;
determining, using the one or more computing device processors, the second water data associated with the second water conduit;
determining, using the one or more computing device processors, water use metric data;
modifying, using the one or more computing device processors, the water use metric data; and
computing, using the one or more computing device processors, the water index based on the first water data, the second water data, and the water use metric data, wherein unusable water volume data or waste water volume data is not used in computing the water index;
wherein one or more parameters of a computing device are configured to display a graphical representation of the water index.

2. The method of claim 1, wherein a consumable water weighting factor used for modifying the water use metric or the water index is associated with electro-thermal cooling associated with water.

3. The method of claim 2, wherein at least a portion of the water, received from a water source system, at a system that performs the electro-thermal cooling of the water, is returned to the water source system.

4. The method of claim 1, wherein the first water conduit is associated with a first width and wherein the second water conduit is associated with a second width.

5. The method of claim 1, wherein input signals are received from more than two water-related input signal systems, the input signals comprise water data associated with the more than two water-related input signal systems.

6. The method of claim 1, wherein the water index is based on a type of water.

7. The method of claim 1, wherein the water index is based on a type of water-related application.

8. The method of claim 1, wherein the water use metric data comprises a water consumption volume.

9. The method of claim 1, wherein the first water data or the second water data is based on at least one of a water pipe level, a dam level, a river flow level, a snow level, a river height level, a precipitation level, a rainfall level, a cloud cover level, a temperature level, or a humidity level.

10. The method of claim 1, wherein the first water data comprises a first supply volume and the second water data comprises a second supply volume.

11. The method of claim 1, wherein the water index comprises the water index being relative an index associated with a commodity.

12. The method of claim 1, wherein an exchangeable electronic instrument is created based on the water index, and wherein the exchangeable electronic instrument is exchanged on an exchange platform.

13. The method of claim 1, wherein a water-based virtual instrument is exchanged on exchange platform, and wherein the water-based virtual instrument is based on the water index.

14. The method of claim 13, wherein the water-based virtual instrument is associated with a present or future consumption of water.

15. The method of claim 1, further comprising:
determining, using the one or more computing device processors, a first computation technique, wherein the first computation technique is used for computing the water index;
determining, using the one or more computing device processors, a triggering event for modifying the first computation technique; and
modifying, using the one or more computing device processors, based on the triggering event, at least one component of the first computation technique.

16. The method of claim 1, further comprising modifying, using the one or more computing device processors, the first water data based on the first water supply volume associated with the first water conduit, and modifying, using the one or more computing device processors, the second water data based on the second water supply volume associated with the second water conduit.

17. The method of claim 16, wherein the first water supply volume comprises a first relative water supply volume associated with the first water conduit with respect to a total water supply volume in a region associated with the first water conduit, and wherein the second water supply volume comprises a second relative water supply volume associated with the second water conduit with respect to the total water supply volume in the region, the region also being associated with the second water conduit.

18. An apparatus for communicating with disparate water-related input signal systems and generating water-related output signals, the apparatus comprising one or more computing device processors configured for:
establishing a first connection to a first water-related input signal system, the first input signal system being associated with a first water conduit;
receiving a first input signal on the first connection, the first input signal comprising first water data;
establishing a second connection to a second water-related input signal system, the second input signal system being associated with a second water conduit;
receiving a second input signal on the second connection, the second input signal comprising second water data;
establishing a third connection to a computing device;
transmitting an output signal to the computing device, the output signal comprising a water index;
determining the first water data associated with the first water conduit;
determining the second water data associated with the second water conduit;
determining water use metric data; and
computing the water index based on the first water data, the second water data, and the water use metric data,
wherein one or more parameters of a computing device are configured to display a graphical representation of the water index.

19. The apparatus of claim 18, wherein the one or more computing device processors are further configured for:
modifying, using the one or more computing device processors, the first water data based on the first water supply volume associated with the first water conduit, and
modifying, using the one or more computing device processors, the second water data based on the second water supply volume associated with the second water conduit, and
wherein the water index is computed using the modified first water data and the modified second water data.

20. The apparatus of claim 18, wherein an exchangeable electronic instrument is created based on the water index, wherein the water index is not exchangeable on the exchange platform, and wherein the exchangeable electronic instrument is exchangeable on an exchange platform.
